(19) United States
(12) Patent Application Publication
(10) Pub. No.: US 2007/0292024 A1
(43) Pub. Date: Dec. 20, 2007

(54) Application specific noise reduction for motion detection methods

(76) Inventors: Richard L. Baer, Los Altos, CA (US); Aman Kansal, Bellevue, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/472,139

(22) Filed: Jun. 20, 2006

(51) Int. Cl. G06K 9/34

(52) U.S. Cl. 382/173

(57) ABSTRACT

A method includes initializing a density map, identifying regions in a captured image, calculating a center of mass for the regions, updating the density map according to the center of mass, and transforming the data.

### BACKGROUND

Prior art image-based motion detection is based on image differencing. This technique assumes that moving objects will cause non-zero pixels in the difference image. The differencing methods are based on either taking the difference of two subsequent frames or on taking the difference of a captured image from a background image learned over time.

There are several problems with the aforementioned techniques. One, different textures on multiple parts of a single mobile object cause it to be detected as multiple objects. When only part of an object moves, e.g. a person's hand waving, the object may be detected as two disjoint moving objects. Two, light level changes and effects of shadows may cause false positives, e.g. detection of spurious mobile objects. Three, small changes in the background, e.g. swaying of the leaves of a tree in the background, also results in the detection of spurious motion.

Some improvements, e.g. spatially-varying adaptive thresholds, have been considered to improve the accuracy of image-based motion detection. The improvements are application specific and anticipate knowledge of the expected image scenes or other motion activity parameters.

### SUMMARY

A method includes initializing a density map, identifying regions in a captured image, calculating a center of mass for the regions, updating the density map according to the center of mass, and transforming the data.

### BRIEF DESCRIPTION OF THE DRAWINGS

FIG. 1 illustrates a process flowchart according to the invention.

FIG. 2 further describes the process flowchart associated with step 22.

### DETAILED DESCRIPTION

The method segments the image into two sets of pixels: foreground and background. The background pixels are those pixels where the value of the difference computed by the image differencing based motion detection algorithm is below a preset threshold. The foreground pixels are those pixels that exceed the threshold. The foreground pixels are accepted by the data transform at each time instant an image frame is captured. The background pixels are “zeroed” out over time.

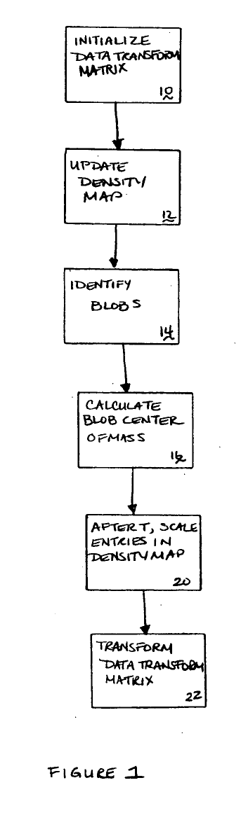

FIG. 1 illustrates a process flowchart corresponding to the present invention.

In step 10, a data transform is initialized according to the following parameters: expected dwell time, minimum size, maximum size, and minimum resolution. Input to the data transform is the output of any image differencing based motion detection method.

The expected dwell time (T) corresponds to the predicted time a foreground object will remain in the scene. Depending on the application, objects may appear in the scene and stay there for varying durations. The value of T is required to be greater than the interval between the capture of successive frames used in the image differencing step.

The minimum size (MIN) of an object to be detected is measured in the number of pixels occupied in the field of view. The minimum size may be calculated based on the knowledge of the actual physical size of the object to be detected and its distance from the camera.

The maximum size (MAX) of an object to be detected is also measure in the number of pixels occupied in the field of view.

The minimum resolution (B) is the accuracy, in number of pixels desired for the location coordinates of each motion event. B must be an integral value greater than 1 and smaller than the minimum of the image dimensions, X and Y.

In step 12, a density map (D) is updated. The density map is a matrix of size X/B by Y/B is initialized to zero. A density map represents the degree of activity, e.g. how much motion has been recently observed in a region. In step 20_{[RLB2]}, the density map (D) is updated. For each instance, for each center of mass coordinate (x,y), the indices of D are computed to be x/B, y/B and the value of D at those indices is incremented by one. Thus, this provides a decaying_{[RLB3]} running average of the scene. The density map suggests that subtle changes will be interpreted as motion.

In step 14, “blob” identification occurs. The foreground pixels are denoted to belong to motion events. A set of such pixels that are contiguous form a “blob”. The blobs are determined by coalescing each set of contiguous foreground pixels into a single set. Blob identification is carried out for each time instance at which the foreground data is received from the image differencing based motion detection method.

To reflect the likelihood of the centroid of the blob being located in the captured image, in step 16, the center of mass of each “blob” is calculated. The center of mass is determined by treating each pixel in the blob to be of unit weight, using the image coordinates of the pixel as its location and applying the known formula for the center of mass. In addition, the likelihood of the pixel being included in the detected blob is determined.

In step 20, after each period of time duration T, e.g. 10 minutes, the values of all entries in the density map are scaled, e.g. by 50%. The time duration T is selected to be greater than the image capture time and is determined by the application requirements. The scaling of the values of the entries prevents the map from having infinite memory. This prevents the illusion of a “permanent background”.

In step 22, the output of the data transform occurs.

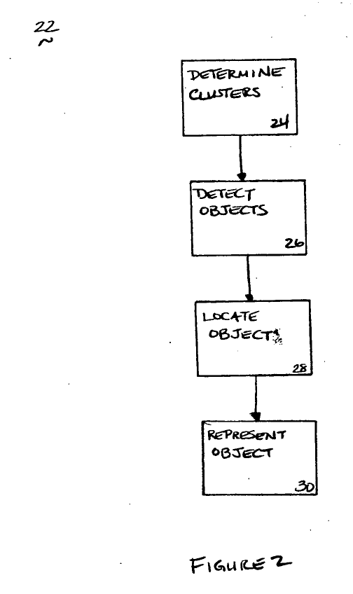

FIG. 2 further describes the process flowchart associated with step 22.

In step 24, clustering is determined. The non-zero entries in the density matrix (D) that are adjacent to at least three other non-zero entries are set to non-zero values in the data transform.

In step 26, object detection occurs. The non-zero entries in D that are contiguous are coalesced together and are considered a single object. _{[RLB4]}The number of entries corresponding to each object is counted. If an object has more than MAX entries, the first MAX entry is retained in the object and the remaining entries are made available for another object. If an object has less then MIN entries, it is ignored.

In step 28, the object is located. The center of mass of the entries in each retained separate object is computed. To illustrate, if the matrix indices computed to be the center of mass denoted (m, n), then the location of the object in the image scene is calculated to be (x, y)=(m*B, n*B).

In step 30, the object is represented. Among all the matrix indices in D corresponding to entries for a single object, the indices that have the lowest and high values are determined. These are multiplied by B to yield the pixel coordinates in the image data representing a rectangle surrounding the detected object. The coordinates of these rectangles and the object locations computed above output as the transformed data.

The transformed data set represents moving objects detected in the difference data greater accuracy than the raw data input to the transform. Spurious motion events occurring due to small changes in the background or sudden fluctuation in lighting or shadows are ignored since they do not yield enough entries in the D matrix. Multiple motion events occurring due to the same object are collected in the clustering step into a single object.

The performance of the data transform in terms of rejected noise increases with the value of T since the transform is able to exploit a larger number of motion events in the computation of D.

We claim:

1. A method comprising:
receiving a difference image indicative of changes between two images; and
mapping the difference image parameters into a single data transform.

2. A method as in claim 1, mapping including:
segmenting the difference image into foreground and background pixels; and
transferring data regarding the foreground pixels into the single data transform.

3. A method as in claim 2, transferring including:
passing at least one of parameters selected from a group including dwell time, minimum object size, maximum object size, and minimum resolution.

4. A method as in claim 3, wherein the parameter is dwell time.

5. A method as in claim 3, wherein the parameter is minimum object size.

6. A method as in claim 3, wherein the parameter is maximum object size.

7. A method as in claim 3, wherein the parameter is minimum resolution.

8. A method as in claim 4, segmenting including blobbing to identify clusters of pixels.

9. A method as in claim 8, for each blob, determining of center of mass and updating a density matrix.

10. A method as in claim 9, updating including:
defining indices associated with the center of mass;
incrementing the value of the indices;
after the dwell time, scaling the values of the associated indices.

11. A method as in claim 9, wherein the scaling is by half.

12. A method as in claim 9, updating including:
clustering the foreground pixels;
detecting an object;
locating the object; and
determining size of the object.

13. A method as in claim 12, clustering including evaluating pixels that are above a first threshold to initiate a cluster formation, the cluster formation includes adjacent pixels that are above a second threshold.

14. A method as in claim 12, detecting an object including:
evaluating contiguous non-zero entries in the density matrix;
when the object is larger than the maximum object size, the entries above the maximum object size are attributed to another object;
when the object is smaller than the minimum object size, no object is detected.
